(19) United States
(12) Patent Application Publication
(10) Pub. No.: US 2021/0060868 A1
(43) Pub. Date: Mar. 4, 2021

(54) PLASTIC FUSION SYSTEM

(71) Applicants: Julie Rais Ellis, Oceanside, CA (US); Christine Devitt Stoliker, Oceanside, CA (US)

(72) Inventors: Julie Rais Ellis, Oceanside, CA (US); Christine Devitt Stoliker, Oceanside, CA (US)

(21) Appl. No.: 17/005,216

(22) Filed: Aug. 27, 2020

Related U.S. Application Data
(60) Provisional application No. 62/892,377, filed on Aug. 27, 2019.

(51) Int. Cl. B29C 65/20; B29C 65/00

(52) U.S. Cl. CPC B29C 65/20; B29C 66/91421; B29C 66/83411; B29C 66/72328

(57) ABSTRACT

A system for fusing plastic materials without bonding agents, such as adhesives, etc., is disclosed. A heat press is used to apply heat and pressure to plastic material sandwiched between heat resistant material. A flatbed heat press, a rotary heat press, or other similar type of thermal roller system may be used. Heat is applied to at least one side of the sandwich and may be applied to both sides of the sandwich simultaneously with equal pressure for a given amount of time. Dual thermostats may be used for application of different beat levels on opposite sides of the sandwich. Reinforcement materials, such as mesh or reinforcement fibers, may be integrated within the layers of plastic prior to fusion to enhance the integrity and/or aesthetic qualities of the fused end product. The plastic may be subjected to multiple applications of heat and pressure to optimize the fusion process.

### CROSS-REFERENCE TO RELATED APPLICATION(S)

This application claims benefit of U.S. Provisional Patent Application No. 62/892,377 filed Aug. 27, 2019, entitled, “PLASTIC FUSION SYSTEM”, the entire disclosure of which is incorporated by reference herein.

### BACKGROUND OF THE INVENTION

### 1. Field of Invention

This invention relates to recycling plastic. More specifically, the present invention is a system for fusing plastic to create a plastic material for manufacturing consumer goods.

### 2. Description of Related Art

Plastic is the workhorse material of the modern economy. Lightweight and durable, it's been used to make a vast number of products since its introduction over 100 years ago.

The production and use of plastic products are growing exponentially year-over-year, and this shows no sign of slowing. The majority of plastic packaging is produced from “virgin stocks” (crude oil), with only 2% globally coming from recycled sources. Further, according to a study, a full 32% of the 78 million tons of plastic packaging produced annually is left to flow into our oceans. This is the equivalent of pouring one garbage truck of plastic into the ocean every minute.

High-density polyethylene “HDPE” bags (plastic recycling symbol #2) and low-density polyethylene “LDPE” bags (plastic recycling symbol #4) are oftentimes used once and are then discarded. The discarded bags litter our environment, ultimately ending up in our landfills, oceans, streams, etc.

As an alternative to recycling or otherwise responsibly discarding waste, some individuals choose to burn their waste, including plastics. Burning or melting plastic releases toxic chemicals into the environment. Pollutants released from burning or melting plastic are transported through the air, and are then deposited onto land or into bodies of water. Some of these pollutants persist for long periods of time in the environment and tend to bio-accumulate, introducing toxic chemicals into the food chain.

Currently, efforts are being made to recycle plastic, when possible and/or convenient. When different types of plastics are melted together, they tend to phase-separate, like oil and water, and set in these layers. The phase boundaries cause structural weakness in the resulting material, meaning that polymer blends are useful in only limited applications. Thus, the current methods for recycling plastic require the plastic materials to be sorted in preparation for recycling. After sorting, the plastic recyclables are then shredded. These shredded fragments then undergo processes to eliminate impurities like paper labels. The cleaned and shredded material is then melted and often extruded into the form of pellets which are then used to manufacture other products.

Each time plastic is recycled, additional virgin materials must be added to help improve the integrity of the material. So, even recycled plastic has new plastic material added in. The same piece of plastic can only be recycled about 2-3 times before its quality decreases to the point where it can no longer be used, requiring it to be discarded.

Based on the foregoing, there is a need in the art for a system of recycling plastic, whereby the same/similar or different types of plastic can be fused together, without melting the plastic into liquid form, to form a usable product. Such a system would reduce the overall amount of plastic waste product and would reduce the amount of chemical pollution released into the air from burning plastic waste or melting plastic as currently required for recycling.

### SUMMARY OF THE INVENTION

A system for fusing plastic includes a heat press, a first piece of heat resistant material, a second piece of heat resistant material, and plastic material disposed between the first piece of heat resistant material and the second piece of heat resistant material. The heat press may be a flatbed heat press or a rotary heat press (or similar thermal roller system). The heat press is configured to uniformly apply a pre-determined amount of pressure across a surface area of the first piece of heat resistant material and the second piece of heat resistant material simultaneously. Additionally, the heat press is configured to uniformly apply a pre-determined amount of heat across the surface area of at least the first piece of heat resistant material. In an embodiment, the heat press is configured to apply a pre-determined amount of heat across the surface area of the first piece of heat resistant material and the second piece of heat resistant material simultaneously. Heat applied to the first and/or second piece of heat resistant material is transferred to the plastic material, such that application of the pre-determined amount of pressure and heat for the pre-determined amount of time is configured to fuse the plastic material together.

In an embodiment, one or more opposing plates or one or more rollers of the heat press are textured.

In an embodiment, at least one piece of the heat resistant material is textured.

In an embodiment, the system further includes a reinforcement material disposed between the plastic material.

In an embodiment, the system further includes a piece of paper having ink disposed thereon. The piece of paper is disposed between the first piece of heat resistant material and the plastic material. Another similar piece of paper may be disposed between the second piece of heat resistant material and the plastic material. The ink is configured to transfer to the plastic material upon heating.

In an embodiment, the heat press includes multiple thermostats, each being configured to regulate the temperature of a given heat plate or roller. As such the temperature of the of the plates or rollers may be regulated independent of one another.

A method of fusing plastic includes sandwiching plastic material between a first piece of heat resistant material and a second piece of heat resistant material. Once sandwiched, the plastic material, the first piece of heat resistant material, and the second piece of heat resistant material are inserted into a heat press. The heat press applies uniform pressure across a surface area of the first piece of heat resistant material and the second piece of heat resistant material simultaneously. Additionally, the heat press applies heat across the surface area of at least the first piece of heat resistant material, wherein the pressure and heat are applied for a pre-determined amount of time to fuse the plastic material together.

In an embodiment, at least one of the first piece of heat resistant material and the second piece of heat resistant material is textured, wherein a texture of the first piece of heat resistant material and/or the second piece of heat resistant material is imprinted on the fused plastic material.

The terms ‘texture’, ‘textured’, or any variation thereof as used throughout this application include, but are not limited to, any form of texturing, wording, design, graphics, pattern, etc.

In an embodiment, the method further includes inverting the fused sheets of plastic and re-sandwiching them between the first piece of heat resistant material and the second piece of heat resistant material; and inserting the fused sheets of plastic, the first piece of heat resistant material, and the second piece of heat resistant material into the heat press, wherein uniform pressure is applied across the surface area of the first piece of heat resistant material and the second piece of heat resistant material simultaneously, and wherein heat is applied across the surface area of at least the second piece of heat resistant material, wherein the pressure and heat are applied for a pre-determined amount of time.

In an embodiment, prior to inserting the plastic material, the first piece of heat resistant material, and the second piece of heat resistant material into the heat press, the method further includes programming a first thermostat to heat a first heat plate to a quantitatively defined temperature; and programming a second thermostat to heat a second heat plate to a quantitatively defined temperature.

In an embodiment, the step of sandwiching the plastic material further comprises disposing a reinforcement material between the plastic material.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 shows a system for fusing plastic, according to an embodiment of the present invention;

FIGS. 2a-2b show a system for fusing plastic, according to an embodiment of the present invention;

FIG. 3 is a flow chart showing a method of fusing plastic, according to an embodiment of the present invention; and

FIG. 4 is a table showing a non-exhaustive list of plastics and the amount of heat and time required for fusion of a given number of layers, according to various embodiments of the present invention.

### DETAILED DESCRIPTION OF PREFERRED EMBODIMENTS

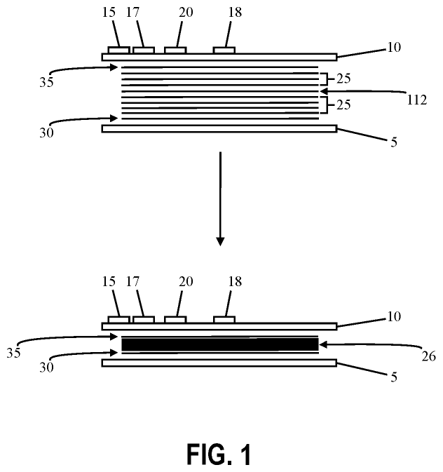

Preferred embodiments of the present invention and their advantages may be understood by referring to FIGS. 1-4, wherein like reference numerals refer to like elements.

The present invention is a system for recycling plastic to create a material that can be used as a fabric for manufacturing a wide range of consumer goods, such as handbags, wallets, golf bags, luggage, footwear, upholstery, etc. Using a heat press to provide systematic control and application of heat and pressure for a pre-determined amount of time, the present system provides a method of uniformly fusing multiple pieces of plastic together without the use of bonding agents, such as adhesives, etc., to form a high-quality recycled material without melting the plastic.

The present system uses a heat press to uniformly apply heat and pressure over the plastic's surface area for a pre-determined amount of time. With reference to FIG. 1, a flatbed heat press 1, e.g., a clamshell press, a swing away press, a draw press, or a hybrid press that combines features of multiple types of flatbed heat presses, may be used. Heat press 1 includes, among other things, plates 5, 10 that oppose one another. Heat press 1 is configured to transition between an open position, whereby plates 5, 10 are separated, and a closed position, whereby plates 5, 10 align with one another and are touching or slightly separated. At least one of plates 5, 10 are heated.

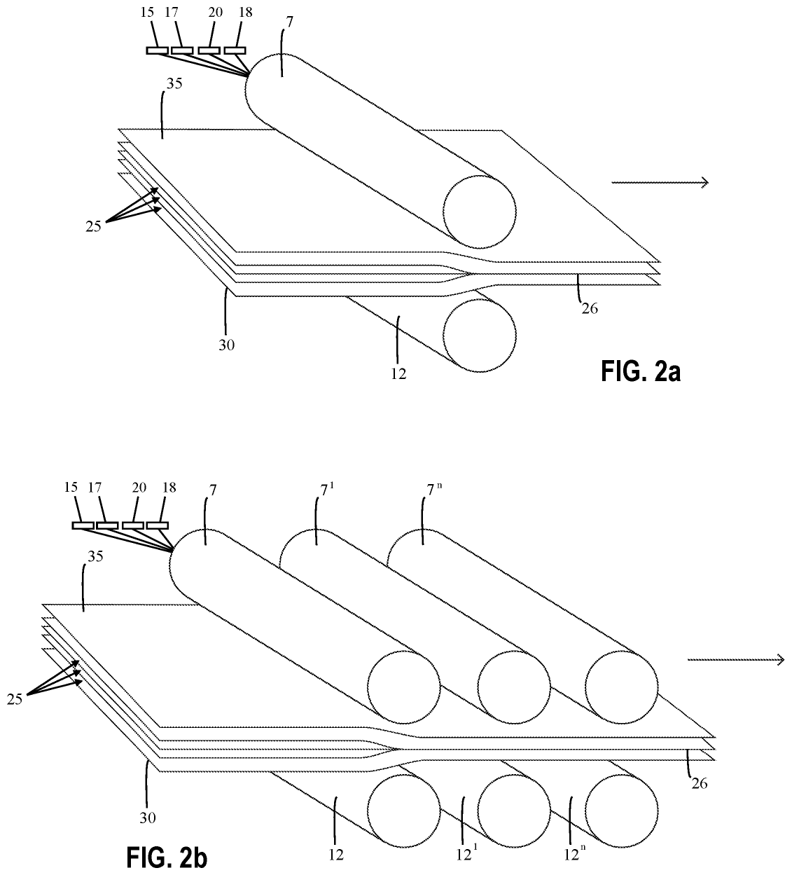

With reference to FIG. 2a, as an alternative to using a flatbed heat press 1, a rotary heat press 3 (or a similar heated roller system, e.g., a rotary iron or roll laminator) may be used. Heat press 3 includes at least one pair of parallel rollers 7, 12 that align with one another and are touching or slightly separated, such that material can be passed between rollers 7, 12. At least one of rollers 7, 12 are heated. With further reference to FIG. 2b, heat press 3 may incorporate additional pairs of rollers 7¹ . . . 7ⁿ, 12¹ . . . 12ⁿ downstream of rollers 7, 12. If incorporated, at least one of rollers 7¹ . . . 7ⁿ, 12¹ . . . 12ⁿ may be heated. As such, material passed through heat press 3 may be subjected to multiple applications of heat and pressure before exiting heat press 3. By using a rotary press, a continuous flow of material can be fed through rollers 7, 12 (and, optionally, subsequent pairs of rollers 7¹ . . . 7ⁿ, 12¹ . . . 12ⁿ), whereby, as material exits a final pair of rollers, the material can be processed, e.g., cooled, delaminated, etc., and rolled into a roll.

Plates 5, 10 and rollers 7 . . . 7ⁿ, 12 . . . 12ⁿ may be heated using any technology known in the art, for example, electric heating coils, heating elements, circulated heated oil, etc. Heat presses 1, 3 are configured to provide uniform application of pressure and heat over a defined surface area of a material for a uniform amount of time. Plates 5, 10 may be any shape or size, depending on the desired application. Likewise, rollers 7 . . . 7ⁿ, 12 . . . 12ⁿ may be any size, e.g., length, circumference, etc., depending on the desired application. Operation of heat presses 1, 3 may be manual, semi-automatic, or fully automatic, whereby, if semi-automatic or automatic, certain operations may be executed using compressed air or hydraulic system(s).

In an embodiment, heat press 1, 3 include thermostat 15 for regulating the temperature of plates 5, 10 and rollers 7, 12. Thermostat 15 is configured to allow a user to set the temperature of plates 5, 10 and rollers 7, 12 to a quantitatively defined temperature, e.g., 310° F. In another embodiment, beat presses 1, 3 include dual thermostats 15, 17, allowing the user to set temperatures for plates 5, 10 and rollers 7, 12, whereby the temperatures are set and regulated independent of each other. For example, heat plate 5 could be set to 280° F. and heat plate 10 could be set to 310° F. Likewise, roller 7 could beset to 250° F. and roller 12 could be set to 280° F. This would be useful, for example, when fusing multiple types of plastic having different optimal fusing temperatures and/or melting points. Thermostats 15, 17 may also be used to regulate temperatures of additional rollers 7¹ . . . 7ⁿ, 12¹ . . . 12ⁿ. Alternatively, additional thermostats (not shown) may be used to independently regulate the temperature of one or more of additional rollers 7¹ . . . 7ⁿ, 12¹ . . . 12ⁿ. The temperatures referred to herein are included for illustrative purposes only, and are not meant to limit the scope of the present invention.

In an embodiment, heat press 1, 3 includes pressure gauge 18. Pressure gauge 18 is configured to allow a user to set the amount of pressure to be applied by press 1, 3. In an embodiment, heat press 1, 3 include timer 20. In an embodiment, timer 20 is configured to provide an audible indication, e.g., a beep or a buzz, when a pre-set amount of time has lapsed.

Method of Use and Manufacture

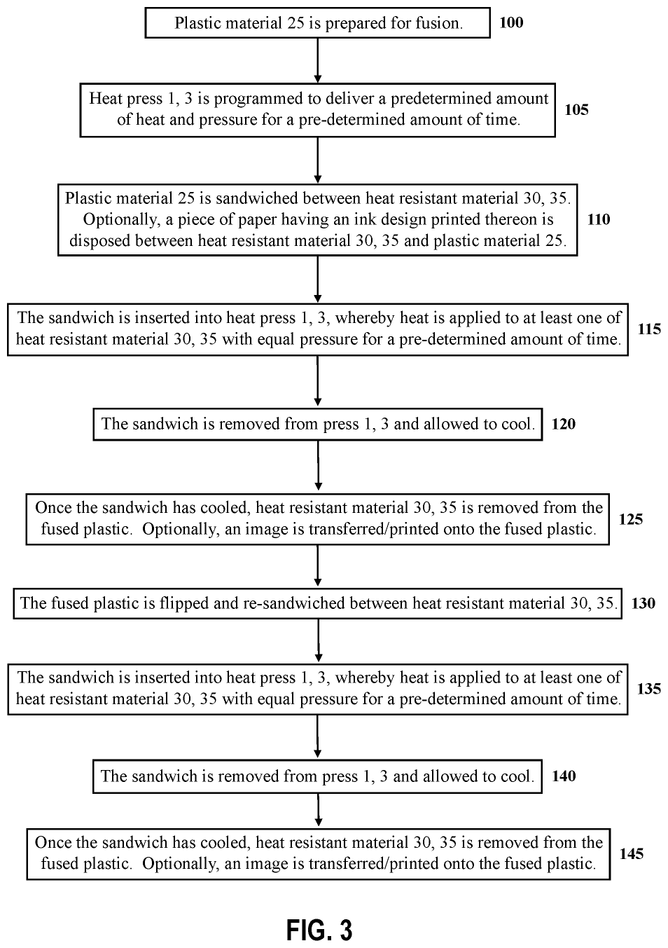

FIG. 3 illustrates a method of fusing plastic, according to an embodiment of the present invention. At step 100, plastic material 25 is prepared for the fusion process. Plastic material 25 may be new, used, or recycled plastic and may include items such as plastic bags, plastic sheets, plastic packaging materials, etc. The foregoing is a non-exhaustive list, meant for illustrative purposes only, and is not in any way intended to limit the scope of the present invention. Preparation of plastic material 25 for the fusion process may include, for example, removal of undesirable items (i.e., items that may result in defects in the fused plastic material 26) from plastic material 25. For example, when preparing a shopping/grocery bag, all seams and handles are removed from the bag, and a side of the bag is cut from top to bottom. Thus, what is left is a single sheet of plastic that can be laid flat for layering. As another example, when preparing a zipper storage bag, the side seams (and, optionally, the bottom seam) and the zipper portion of the bag is removed. Just as with the shopping/grocery bags, this allows the zipper bag to be unfolded and laid flat into a single layer, i.e., sheet, with no folds, creases, or seams. As yet another example, plastic material 25 may be prepared by shredding plastic stock, e.g., plastic bags, plastic sheets, plastic packaging materials, etc., to create smaller pieces or strips of plastic. A shredding machine configured for shredding plastic can be used to shred the plastic stock into usable uniform pieces. Among other benefits, shredding the plastic eliminates the need to sort the colors and types of plastic material, creates more uniform layers, and creates a more consistent thickness of the fused plastic material 26.

Optionally, prior to or during step 100, plastic material 25 is cleaned. The cleaning process is used to remove dirt, markings, imperfections, unwanted particulate etc. from plastic material 25 in preparation for the fusion process. As an example, an anti-static process may be used to remove unwanted particulate, e.g., dirt, dust, etc., from plastic material 25. Additionally, or alternatively, plastic material may be subjected to a chemical cleaning process.

At step 105, thermostat 15 is programmed to adjust and regulate a temperature of heat plate(s) 5, 10 or roller(s) 7, 12 to a desired temperature. In a preferred embodiment, at step 110, the prepared plastic 25 is layered and sandwiched between heat resistant material 30, 35—see FIGS. 1-2b. Heat resistant material 30, 35 may be any material, synthetic, natural, organic or a blend thereof, such as paper or fabric, that allows transfer of heat therethrough from plates 5, 10 to the plastic 25 without being altered, e.g., melted or burned, by the amount of heat being transferred therethrough. Heat resistant material 30, 35 may be coated with a non-stick, heat resistant coating, e.g., polytetrafluoroethylene (“PTFE”), to prevent plastic material 25 from adhering to heat resistant material 30, 35 during the fusion process. As an alternative to using heat resistant material 30, 35, plate(s) 5, 10 or roller(s) 7 . . . 7ⁿ, 12 . . . 12ⁿ may be coated with a non-stick, heat resistant coating to prevent plastic material 25 from adhering to plate(s) 5, 10 or roller(s) 7 . . . 7ⁿ, 12 . . . 12ⁿ during the fusion process. As yet another alternative to using heat resistant material 30, 35, heat resistant sleeve/cover (not shown) is removably disposed on or around plate(s) 5, 10 or roller(s) 7 . . . 7ⁿ, 12 . . . 12ⁿ to prevent plastic material 25 from adhering to plate(s) 5, 10 or roller(s) 7 . . . 7ⁿ, 12 . . . 12ⁿ during the fusion process. Using a coated plate(s) 5, 10 or roller(s) 7 . . . 7ⁿ, 12 . . . 12ⁿ or a heat resistant sleeve/cover eliminates the need for a separate heat resistant material 30, 35, thereby mitigating waste production.

Optionally, at step 110, reinforcement material 112 is disposed between the layers of plastic 25. Reinforcement material 112 provides additional structural integrity to the fused plastic material 26. Additionally, reinforcement material may provide aesthetic benefits, e.g., added texturing, to the fused plastic material 26. Examples of reinforcement material 112 include, but are not limited to, meshes, screens, netting, fibers/filaments (e.g., glass fibers, carbon fibers, cellulose, high strength polymers, hair, etc.), etc. Reinforcement material 112 may be synthetic, natural, organic, or other hybrid material.

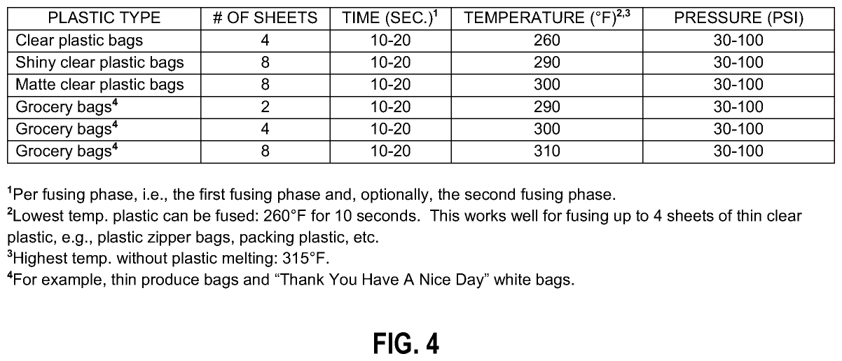

At step 115, the sandwiched plastic (with optional reinforcement material 112) is placed, fed or otherwise inserted into heat press 1, 3, whereby uniform pressure is applied across a surface area of both pieces of heat resistant material 30, 35 simultaneously and a uniform amount of heat is applied to at least one piece of heat resistant material 30, 35 for a pre-determined amount of time. The heat applied to the pieces of heat resistant material 30, 35 is transferred to the plastic 25, thereby fusing plastic material 25. The amount of heat and time for the fusion process varies, depending, e.g., on the number of layers, sheets, or amount (i.e., thickness of the aggregated plastic, e.g., if shredded plastic is used) of plastic and the type of plastic being fused. For illustrative purposes only, FIG. 4 provides a non-exhaustive list of plastics and the amount of heat and time required for fusion of a given number of layers, or sheets. At step 120, the sandwich is removed from the press 1, 3 and is allowed to cool for a pre-determined amount of time, for example, for at least 15 seconds. Optionally, at step 125, once the sandwich has cooled, heat resistant material 30, 35 is removed from the fused plastic material 26. Step 125 is optional, insofar as heat resistant material 30, 35 may not be removed right away, but, instead, by an end user at a later time. For example, if a roll of fused plastic material 26 is produced using rotary heat press 3, the beat resistant material could be left on as a protective barrier until time to use the material.

Upon completion of the foregoing steps (i.e., the initial fusing phase), the following steps (i.e., the second fusing phase) may optionally be added to further enhance the quality and/or characteristics of the fused plastic material 26. At step 130, the fused plastic material 26 is flipped, i.e., the side that was facing up, for example, during the initial fusing phase is now facing down and vice versa, whereby the fused plastic material 26 is re-sandwiched between the pieces of heat resistant material 30, 35. At step 135, the sandwich is placed, fed or otherwise inserted into heat press 1, 3, whereby uniform pressure is applied across a surface area of both pieces of heat resistant material 30, 35 simultaneously and a uniform amount of heat is applied to at least one piece of heat resistant material 30, 35 for a pre-determined amount of time. At step 140, the sandwich is removed from heat press 1, 3 and is allowed to cool for a pre-determined amount of time, for example, for at least 15 seconds. Optionally, at step 145, once the sandwich has cooled, heat resistant material 30, 35 is removed from the fused plastic material 26 to reveal the fused plastic material 26. Just as with step 125, step 145 is optional, insofar as heat resistant material 30, 35 may not be removed right away, but, instead, by an end user at a later time.

In an embodiment, a print is transferred onto a surface of the fused plastic material 26. The print may be applied during one or more of the heating processes, e.g., at step 115 and/or 135, while the plastic is being fused. Additionally, or alternatively, the print may be applied after the fusion process, once the fused plastic material 26 has cooled. As an example, during the initial or subsequent heating process(es), a print may be transferred onto a surface of plastic material 25 using a sublimation printing process. For the sublimation process, a piece of paper (not shown) having an ink design printed thereon is disposed between heat resistant material 30, 35 and plastic material 25. During the heating process(es), the ink turns into gas and combines with plastic material 25 during the fusion process. Additionally, or alternatively, once the fusion process is complete and plastic material 25 has cooled, a print can be printed directly onto the fused plastic material 26 using any known printing techniques.

In an embodiment, one or both of the pieces of heat resistant material 30, 35 are textured. Additionally, or alternatively, at least one of plates 5, 10 or rollers 7¹ . . . 7ⁿ, 12¹ . . . 12ⁿ are textured. Plastic material 25 softens as heat is administered during the fusion process, such that, as pressure is applied by heat press 1, 3, a texture (e.g., an image, a graphic, a design, and/or a pattern) standing out in relief from material 30, 35, plate 5, 10, or roller 7¹ . . . 7ⁿ, 12¹ . . . 12ⁿ is imprinted or debossed into an exterior surface of fused plastic material 26. As fused plastic material 26 cools and hardens, the imprint sets. Thus, by using an embossed or textured heat resistant material 30, 35 and/or plate(s) 5, 10 or rollers 7¹ . . . 7ⁿ, 12¹ . . . 12ⁿ during the fusion process, the user is able to create a unique texture, wording, design, graphic, and/or pattern on one or both sides of the fused plastic material 26.

The invention has been described herein using specific embodiments for the purposes of illustration only. It will be readily apparent to one of ordinary skill in the art, however, that the principles of the invention can be embodied in other ways. Likewise, it will be readily apparent that the features, functions, elements, and/or steps of the present invention disclosed herein can be used in any combination or order to produce various embodiments of the present invention. Therefore, the invention should not be regarded as being limited in scope to the specific embodiments disclosed herein, but instead as being fully commensurate in scope with the following claims.

I claim:

1) A system for fusing plastic comprising:
a) a heat press;
b) a first piece of heat resistant material;
c) a second piece of heat resistant material, wherein at least one of the first piece of heat resistant material and the second piece of heat resistant material is textured; and
d) plastic material disposed between the first piece of heat resistant material and the second piece of heat resistant material,
wherein the heat press is configured to uniformly apply a pre-determined amount of pressure across a surface area of the first piece of heat resistant material and the second piece of heat resistant material simultaneously, wherein the heat press is configured to uniformly apply a pre-determined amount of heat across the surface area of the first piece of heat resistant material, wherein application of the pre-determined amount of pressure and heat for a pre-determined amount of time is configured to fuse the plastic material together, wherein a texture of the at least one of the first piece of heat resistant material and the second piece of heat resistant material is imprinted on the fused plastic material.

2) The system of claim 1, wherein the heat press is a flatbed heat press.

3) The system of claim 2, wherein at least one of two opposing plates of the heat press is textured.

4) The system of claim 1, wherein the heat press is a rotary heat press.

5) The system of claim 4, wherein at least one roller of the heat press is textured.

6) The system of claim 1, further comprising a reinforcement material disposed between the plastic material.

7) The system of claim 1, further comprising a piece of paper having ink disposed thereon, wherein the piece of paper is disposed between the first piece of heat resistant material and the plastic material, wherein the ink is configured to transfer to the plastic material as heat is applied to the first piece of heat resistant material.

8) A system for fusing plastic comprising:
a) a heat press;
b) a first piece of heat resistant material;
c) a second piece of heat resistant material; and
d) plastic material disposed between the first piece of heat resistant material and the second piece of heat resistant material,
wherein the heat press is configured to uniformly apply a pre-determined amount of pressure and heat to an exterior surface of the first piece of heat resistant material and the second piece of heat resistant material simultaneously for a pre-determined amount of time, wherein application of the pre-determined amount of pressure and heat for the pre-determined amount of time is configured to fuse the plastic material together.

9) The system of claim 8, wherein the heat press is a flatbed heat press comprising a first heat plate and a second heat plate, wherein the first heat plate and the second heat plate oppose one another.

10) The system of claim 9, wherein at least one of the first heat plate and the second heat plate is textured.

11) The system of claim 9, wherein the heat press comprises a first thermostat and a second thermostat, wherein the first thermostat is configured to regulate a temperature of the first heat plate, and wherein the second thermostat is configured to regulate a temperature of the second heat plate, wherein the temperature of the first heat plate and the temperature of the second heat plate are independent of one another.

12) The system of claim 8, wherein at least one of the first piece of heat resistant material and the second piece of heat resistant material is textured.

13) The system of claim 8, wherein the heat press is a rotary heat press comprising a first heated roller and a second heated roller.

14) The system of claim 13, wherein the heat press comprises a first thermostat and a second thermostat, wherein the first thermostat is configured to regulate a temperature of the first heated roller, and wherein the second thermostat is configured to regulate a temperature of the second heated roller, wherein the temperature of the first heated roller and the temperature of the second heated roller are independent of one another.

15) The system of claim 8, further comprising a piece of paper having ink disposed thereon, wherein the piece of paper is disposed between the first piece of heat resistant material and the plastic material, wherein the ink is configured to transfer to the plastic material as heat is applied to the first piece of heat resistant material.

16) The system of claim 8, further comprising a reinforcement material disposed between the plastic material.

17) A method of fusing plastic, comprising:
a) sandwiching plastic material between a first piece of heat resistant material and a second piece of heat resistant material, wherein at least one of the first piece of heat resistant material and the second piece of heat resistant material is textured; and
b) inserting the plastic material, the first piece of heat resistant material, and the second piece of heat resistant material into a heat press, wherein uniform pressure is applied across a surface area of the first piece of heat resistant material and the second piece of heat resistant material simultaneously, and wherein heat is applied across the surface area of at least the first piece of heat resistant material, wherein the pressure and heat are applied for a pre-determined amount of time to fuse the plastic material together, wherein a texture of the at least one of the first piece of heat resistant material and the second piece of heat resistant material is imprinted on the fused plastic material.

18) The method of claim 17, wherein the method further comprises the steps of:
a) inverting the fused sheets of plastic and re-sandwiching them between the first piece of heat resistant material and the second piece of heat resistant material; and
b) inserting the fused sheets of plastic, the first piece of heat resistant material, and the second piece of heat resistant material into the heat press, wherein uniform pressure is applied across the surface area of the first piece of heat resistant material and the second piece of heat resistant material simultaneously, and wherein heat is applied across the surface area of at least the second piece of heat resistant material, wherein the pressure and heat are applied for a pre-determined amount of time.

19) The method of claim 17, wherein, prior to inserting the plastic material, the first piece of heat resistant material, and the second piece of heat resistant material into the heat press, the method further comprises:
a) programming a first thermostat to heat a first heat plate to a quantitatively defined temperature; and
b) programming a second thermostat to heat a second heat plate to a quantitatively defined temperature.

20) The method of claim 17, wherein the step of sandwiching the plastic material further comprises disposing a reinforcement material between the plastic material.
